(19) United States
(12) Patent Application Publication
(10) Pub. No.: US 2006/0091249 A1
(43) Pub. Date: May 4, 2006

(54) Breaker bar

(75) Inventor: Alan Potts, Derbyshire (GB)

Correspondence Address: NIKOLAI & MERSEREAU, P.A., 900 SECOND AVENUE SOUTH, SUITE 820, MINNEAPOLIS, MN, 55402, US

(73) Assignee: MMD Design & Consultancy Limited, Derbyshire (GB)

(21) Appl. No.: 11/251,702

(22) Filed: Oct. 17, 2005

Related U.S. Application Data
(63) Continuation of application No. PCT/GB04/01652, filed on Apr. 16, 2004.

(30) Foreign Application Priority Data
Apr. 17, 2003 (GB) 0308933.1

(51) Int. Cl. B02C 13/28

(52) U.S. Cl. 241/236; 241/294

(57) ABSTRACT

A mineral breaker bar assembly for a mineral breaker having at least one breaker drum assembly rotatably mounted in a housing, the breaker bar assembly having an elongate support body adapted for mounting on the mineral breaker housing and having a plurality of breaker teeth mounted on the elongate support body, each of the breaker teeth being adjustably mounted on the elongate support body to enable the height of each breaker tooth relative to the support body to be individually adjusted.

The present invention relates to a mineral breaker bar assembly and to a mineral breaker including such an assembly.

Mineral breakers are known housing a pair of mineral breaker drum assemblies rotatably mounted in a housing with a breaker bar located beneath the drum assemblies. An example of such a mineral breaker is described in our European patent specification 0246775.

With this type of mineral breaker, when mineral is deposited onto the drum assemblies, a first breaking action is performed as the mineral breaker drum assemblies rotate and direct the deposited mineral into and through an elongate passageway between the drum assemblies. As broken mineral flows out from beneath the passageway inbetween the drum assemblies, a second breaking action is performed between the breaker bar and the breaker drum assemblies.

According to one aspect of the present invention there is provided a mineral breaker bar assembly for a mineral breaker having at least one breaker drum assembly rotatably mounted in a housing, the breaker bar assembly having an elongate support body adapted for mounting on the mineral breaker housing and having a plurality of breaker teeth mounted on the elongate support body, each of the breaker teeth being adjustably mounted on the elongate support body to enable the height of each breaker tooth relative to the support body to be individually adjusted.

According to another aspect of the invention there is provided a mineral breaker having at least one breaker drum assembly rotatably mounted in a housing and including a breaker bar assembly as defined above.

Various aspects of the present invention are hereinafter described with reference to the accompanying drawings, in which:

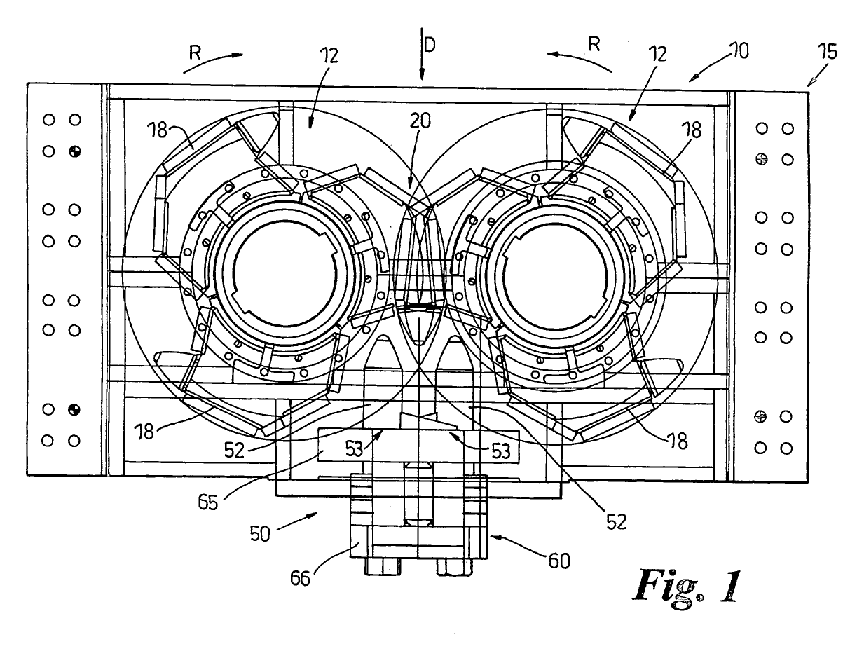

FIG. 1 is an end view, partly broken away, of a mineral breaker according to an embodiment of the present invention;

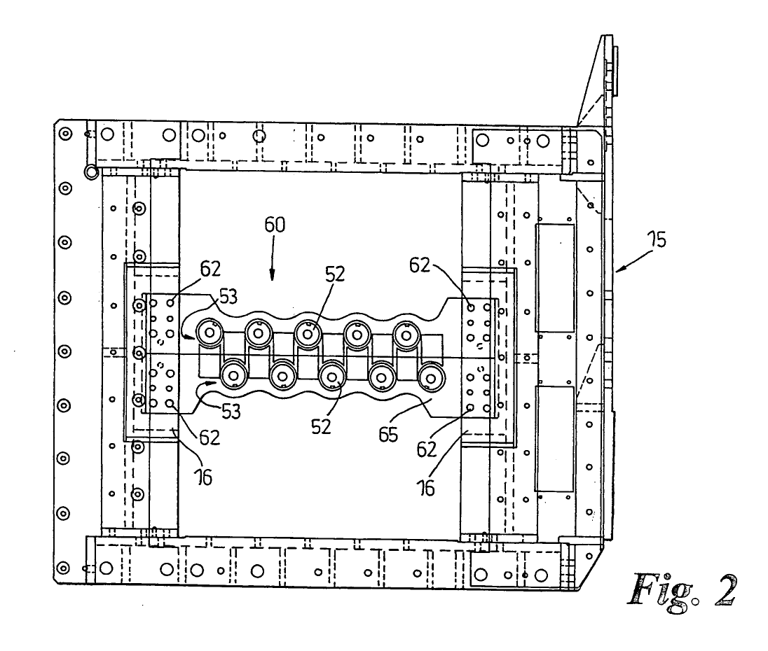

FIG. 2 is a plan view of the mineral breaker housing shown in FIG. 1 with the breaker drum assemblies removed;

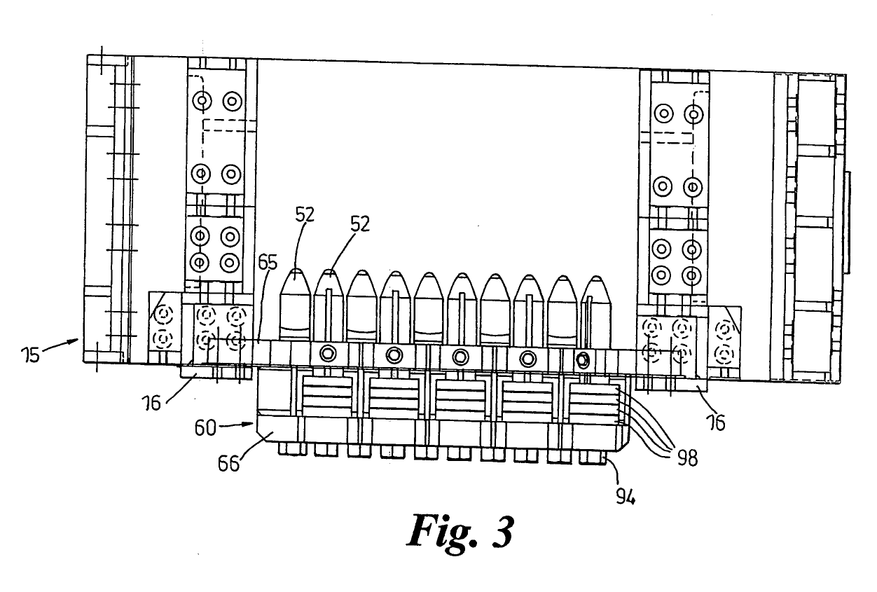

FIG. 3 is a side view, partly broken away, of the housing shown in FIG. 2;

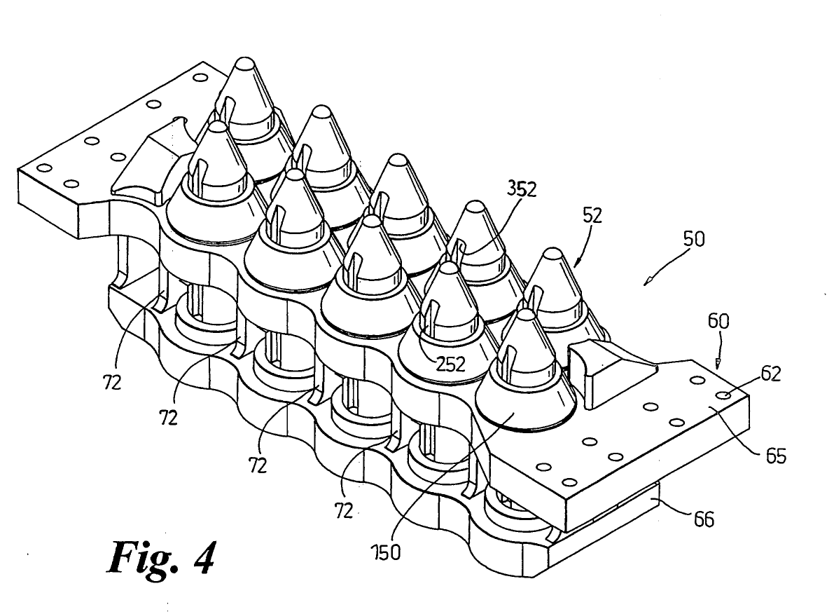

FIG. 4 is a perspective view from above of a breaker bar assembly according to an embodiment of the present invention;

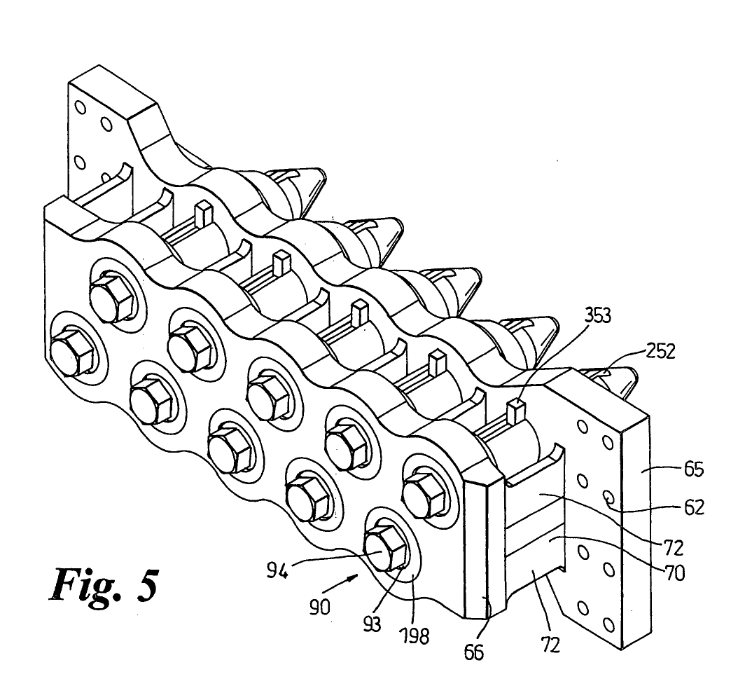

FIG. 5 is a perspective view from below of the breaker bar assembly shown in FIG. 4;

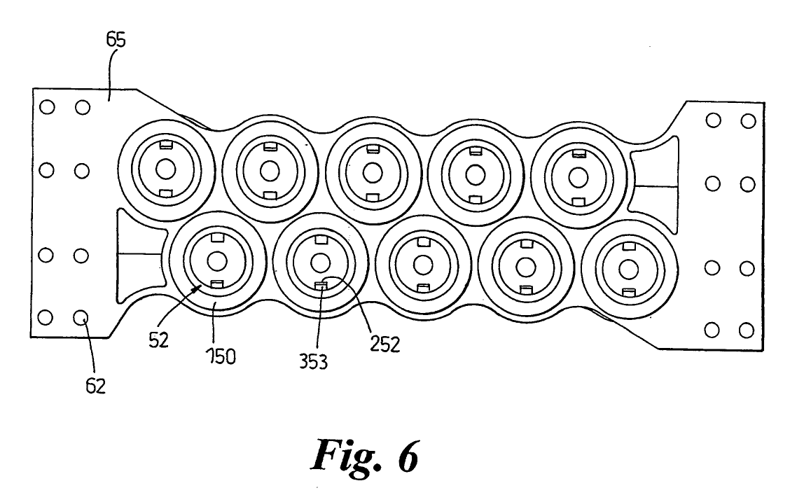

FIG. 6 is a plan view from above of the breaker bar assembly shown in FIG. 4;

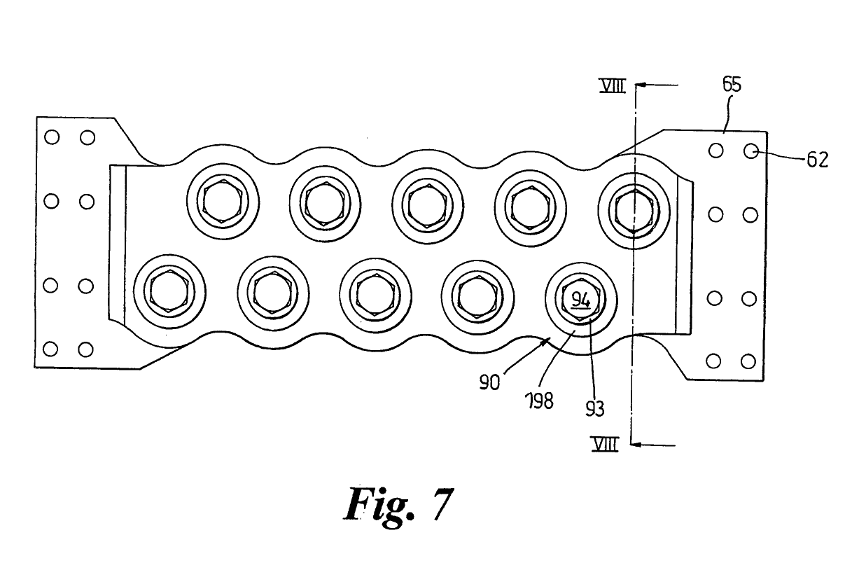

FIG. 7 is a plan view from below of the breaker bar assembly shown in FIG. 4;

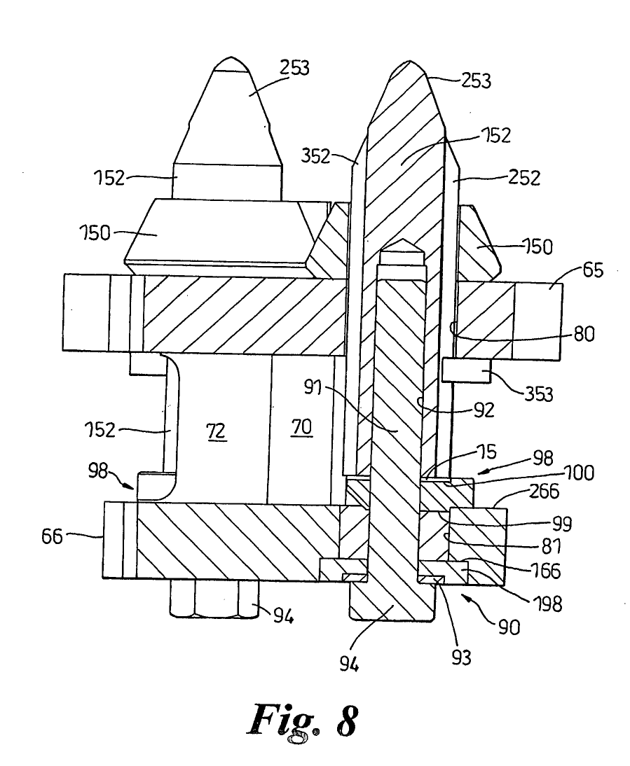

FIG. 8 is a sectional view taken along line VIII-VIII in FIG. 7;

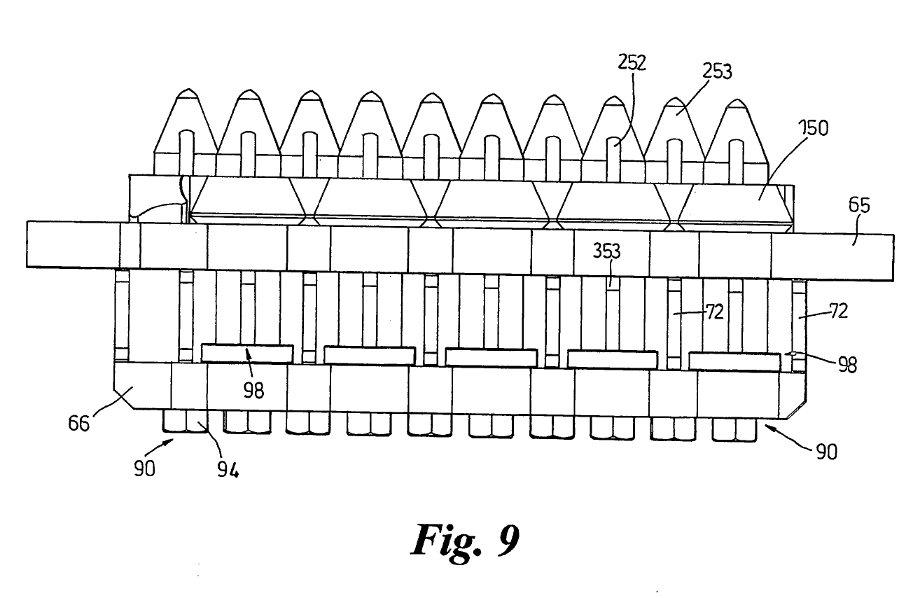

FIG. 9 is a side view of the breaker bar assembly shown in FIG. 4;

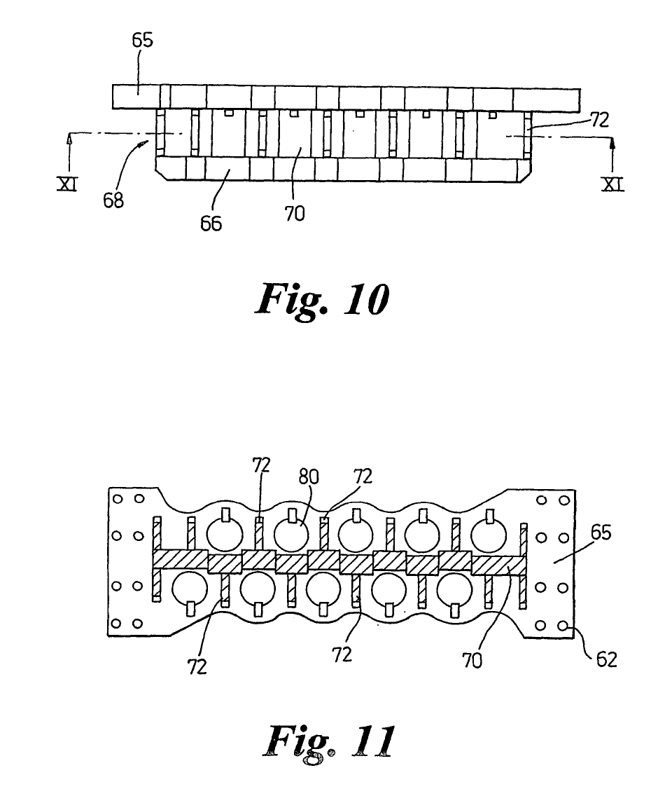

FIG. 10 is a side view of the breaker bar assembly of FIG. 4 with all breaker teeth removed;

FIG. 11 is a sectional view along line XI-XI in FIG. 10;

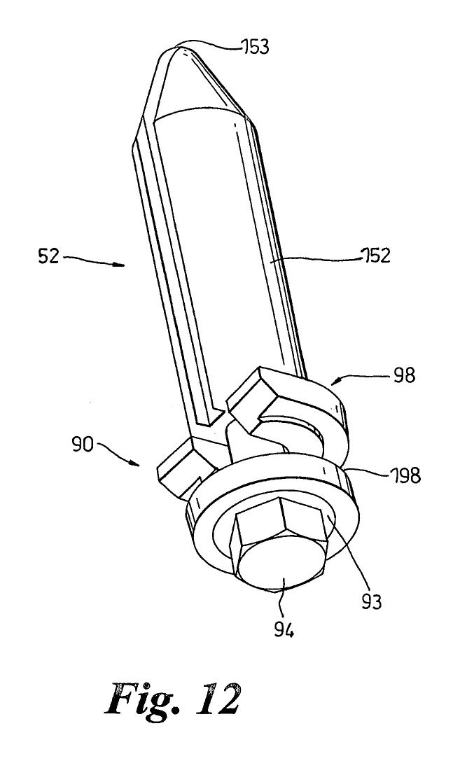

FIG. 12 is a perspective view from below showing a tooth and axial adjustment means of the breaker bar assembly of FIG. 4;

A mineral breaker 10 according to an embodiment of the present invention is illustrated in FIGS. 1 to 3. The mineral breaker 10 includes a pair of breaker drum assemblies 12 which are rotatably mounted within a housing 15.

The breaker drum assemblies 12 each include a plurality of radially projecting breaker teeth 18. In use, the drum assemblies 12 are driven in contra-rotating directions, as indicated by arrow R, such that mineral deposited onto the drum assemblies from above, as indicated by arrow D, is acted upon by opposing teeth 18 on the drum assemblies 12 and caused to flow through a passageway 20. The passageway 20 defined inbetween the adjacent drum assemblies 12 and so is elongate and extends longitudinally along the length of the drum assemblies 12.

The teeth 18 on each breaker drum assembly 12 are preferably arranged in circumferentially extending groups of teeth with the groups being spaced along the axis of the drum assembly such that an annular gap is defined inbetween adjacent groups of teeth. In the illustrated embodiment, there are three teeth 18 in each group. It is envisaged that there may be more or less than three teeth 18 in each group.

The groups of teeth on respective drive assemblies 12 are staggered such that a group of teeth on one drum assembly is located opposite to an annular gap defined between two adjacent groups of teeth on the opposite drum assembly.

Preferably the drum assemblies 12 are mounted in the housing 15 with their longitudinal axes spaced apart to enable the teeth on one drum assembly to enter into the annular gaps on the opposed drum assembly 12.

The drum assemblies 12 may be, for example, constructed and arranged in accordance with those described in our European patent specifications 0167178, 0096706 or 0114725.

A breaker bar assembly 50 is located beneath the passageway 20 and includes a plurality of upwardly projecting breaker teeth 52 which co-operate with opposed breaker teeth 18 of respective breaker drum assemblies 12.

The teeth 52 are mounted on an elongate support body 60 which is mounted on the housing 15 so as to extend longitudinally in the longitudinal direction of the passageway 20; that is, in the longitudinal direction of the drum assemblies 12. The teeth 52 are arranged in two rows 53 of teeth wherein the teeth 52 in each row 53 are spaced longitudinally along the support body 60.

One row 53 of teeth 52 is arranged to co-operate with one drum assembly 12 and the other row 53 of teeth 52 is arranged to co-operate with the other drum assembly 12.

The spacing between teeth 52 in a given row 53 is such that an individual tooth 52 is positioned in alignment with an annular gap between adjacent circumferential groups of teeth 18 on the opposed drum assembly 12 with which it co-operates.

Thus as mineral flows downwardly out of the passageway 20, the flow is divided as the movement of the left-hand drum assembly 12 (FIG. 1) causes the mineral to flow to the left-hand side of the breaker bar assembly and as the movement of the right-hand drum assembly 12 causes the mineral to flow to the right-hand side of the breaker bar assembly 50.

During such movement of the left-hand breaker drum assembly 12, the teeth 18 of that drum assembly are caused to sweep past the left-hand row 53 of teeth 52 and similarly the teeth 18 on the right-hand drum 12 are caused to sweep past the right-hand row 53 of teeth 52.

The opposed teeth 18, 52 thereby act to further break down the size of mineral; the maximum size of mineral after such break down being determined by the amount by which each tooth 52 projects into the annular gap defined between the adjacent circumferential groups of teeth 18 with which it co-operates, viz. the greater the amount by which a tooth 52 projects into an annular gap, the smaller the reduction in size of mineral lumps emerging from the mineral breaker.

As illustrated in FIGS. 1 to 3, the support body 60 is fixedly mounted at each end onto the housing 15, preferably by bolts (not shown), passing through bolt holes 62 in the support body 60 and a housing ledge 16 upon which the support body 60 is seated. The support body 60 is thereby located at a fixed position relative to the housing 15.

In order to adjust the amount by which each tooth 52 projects into the opposed annular gap, each tooth 52 is adjustably mounted on the support body 60 such that the amount by which it projects above the support body 60 may be selectively adjusted. Accordingly it is possible to accurately determine the position of each tooth 52 and so ensure that the maximum lump size of mineral emerging from the mineral breaker is maintained at a desired maximum.

As best illustrated in FIGS. 4 to 12, the breaker bar assembly 50 preferably includes a support body 60 which comprises an upper elongate plate 65 which overlies a lower elongate plate 66. The upper and lower plates 65, 66 are spaced laterally apart and secured together by a series of plate-like webs 68. Preferably a central web 70 is provided which extends longitudinally along the elongate plates 65, 66 and also, laterally extending webs 72 are also provided. The position and number of webs 68 are chosen to provide the elongate body 60 with a desirable amount of strength for resisting the breaking forces experienced during breaking of mineral between opposed teeth 18, 52.

Preferably the plates 65, 66 and plate-like webs 68 are composed of the same or different suitable steels which are weldable together to enable the elongate support body 60 to be fabricated by welding the webs 68 to plates 65, 66.

The upper and lower plates 65, 66 are provided with aligned pairs of teeth accommodating bores 80, 81 respectively through which a tooth 52 is able to axially slide. Preferably as shown, each tooth 52 is of shaft-like form; that is, it has an elongate cylindrical body 152 of constant cross-section along its length. Its upper terminal end 253 is shaped, preferably in the shape of a cone, to define a tooth formation.

The bore 80 which accommodates the upper portion of the tooth body 152 is preferably dimensioned such that there is a close tolerance fit to thereby reduce to a minimum lateral movement between the tooth body 152 and the upper plate 65. If desired, it is envisaged that bore 80 may be defined by a bush inserted into plate 65.

To adjust the axial position of a tooth 52 relative to the support body 50, axial adjustment means 90 are provided. The adjustment means 90 preferably comprises a bolt 91 which is screw threadedly received in a threaded bore 92 extending axially along the tooth body 152 from its lower terminal end which is defined by a lower axial abutment face 153.

The bolt 91 has a bolt head 94 which abuts against lower face 166 of plate 66 and on tightening of the bolt 91 serves to draw abutment face 153 into abutment with the upper face 266 of the lower plate 66.

The size of bore 81 in lower plate 66 is preferably large enough to permit the elongate body 152 to pass therethrough. Accordingly, it is possible to insert the tooth 52 upwardly from a position below the breaker bar assembly 50 until the tooth 52 projects above the upper plate 65.

To set the axial position of the tooth 52, one or more packing members 98 are located inbetween the abutment face 153 and the upper face 266 of plate 66. The bolt 91 is then tightened to bring the abutment face 153 into tight abutment with the upper face 266 via the one or more packing members 98.

Each packing member 98 is preferably of generally U-shape to enable the packing member 98 to be inserted in a lateral direction relative to the bolt 91 and so enable it to be positioned between faces 153, 266 without requiring removal of the bolt 91.

Preferably, each packing member 98 has a cylindrical projection 99 on its lower face and a cylindrical seat 100 on its upper face to enable the packing members 98 to be stacked and to be inserted into bore 81 and receive the lower terminal end of the tooth without lateral play. Packing members 98 of different axial thickness may be used to enable the axial position of each tooth to be accurately set at any desired position.

Preferably the bolt head 94 abuts against the lower face 166 of plate 66 via an annular packing member 198 and one or more washers 93. Preferably the washers 93 are Belville type washers which serve to also act to restrain the bolt 91 against untightening rotation due to vibration during use.

Alternatively or in addition, anti-rotation means, such as a plastics insert, may be incorporated into the tooth body 152 to restrain unwanted untightening rotation of the bolt 91.

To prevent rotation of the tooth body 152 within the support body 50, a keyway 252 is preferably provided which extends longitudinally axially along the tooth body 152. The keyway 252 co-operates with a projection 353 which is formed on the upper plate 65. Optionally, an additional keyway 352 may be provided which enables the tooth 92 to be removed, rotated and re-inserted for continued use. This is advantageous for extending the useable life of the tooth since, in use, it is expected that only the side of the tooth 52 facing opposed teeth 18 will be subjected to maximum wear.

Preferably, as seen in particular in FIG. 4, strengthening collars 150 are provided for extending the axial extent of bores 68 and providing additional metal for resisting brealing forces experienced when teeth 52 co-operate with teeth 18 to break mineral. Preferably the collars 150 are fixedly secured to the upper plate 65 by welding.

The collars 150 illustrated in FIG. 4 are generally frusto-conical in shape. However, it is envisaged that other shapes may be adopted.

1. A mineral breaker bar assembly for a mineral breaker having at least one breaker drum assembly rotatably mounted in a housing, the breaker bar assembly having an elongate support body adapted for mounting on the mineral breaker housing and having a plurality of breaker teeth mounted on the elongate support body, each of the breaker teeth being adjustably mounted on the elongate support body to enable the height of each breaker tooth relative to the support body to be individually adjusted.

2. A breaker bar assembly according to claim 1 wherein the support body comprises an upper elongate plate directly overlying a lower elongate plate, the upper and lower plates being secured together and spaced laterally apart by at least one web.

3. A breaker bar assembly according to claim 2 wherein said at least one web extends longitudinally in the longitudinal direction of the elongate support body.

4. A breaker bar assembly according to claim 1 wherein each tooth includes an elongate tooth body having a tooth formation at one terminal end, the elongate tooth body being axially slidably received in the support body to enable its longitudinal position relative to the support body to be adjusted.

5. A breaker bar assembly according to claim 4 wherein each tooth is provided with an axial adjustment device for lockingly locating the tooth at the desired longitudinal position relative to the support body.

6. A breaker bar assembly according to claim 5 wherein the axial adjustment means is located at an axial end of the elongate tooth body opposite to said one terminal end.

7. A breaker bar assembly according to claim 2 wherein the body of each tooth is axially slidable through both the upper and lower plates.

8. A breaker bar assembly according to claim 1 wherein each tooth is formed from an elongate bar of constant circular cross-section.

9. A breaker bar assembly according to claim 8 wherein the elongate tooth body of each tooth includes at least one keyway extending longitudinally along its length for co-operation with a projection on the support body to prevent rotation of the elongate bar relative to the support body.

10. (canceled)

11. A mineral breaker having at least one mineral breaker drum assembly rotatably mounted in a housing and including a breaker bar assembly according to claim 1.

12. A mineral breaker according to claim 11 including a pair of mineral breaker drum assemblies each having radially projecting breaker teeth, the drum assemblies being spaced laterally apart to define an elongate passageway therebetween through which mineral flows in a direction from above to below the mineral breaker drum assemblies as it is being broken down by said drum assemblies, the breaker bar assembly being located beneath said passageway and being arranged such that its support body extends longitudinally in the longitudinal direction of the passageway and its breaker teeth co-operate with teeth on the mineral breaker drum assemblies to break mineral exiting from said passageway.

13. (canceled)

14. A breaker bar assembly according to claim 2 wherein each tooth includes an elongate tooth body having a tooth formation at one terminal end, the elongate tooth body being axially slidably received in the support body to enable its longitudinal position relative to the support body to be adjusted.

15. A breaker bar assembly according to claim 3 wherein each tooth includes an elongate tooth body having a tooth formation at one terminal end, the elongate tooth body being axially slidably received in the support body to enable its longitudinal position relative to the support body to be adjusted.

16. A breaker bar assembly according to claim 14 wherein each tooth is provided with an axial adjustment device for lockingly locating the tooth at the desired longitudinal position relative to the support body.

17. A breaker bar assembly according to claim 15 wherein each tooth is provided with an axial adjustment device for lockingly locating the tooth at the desired longitudinal position relative to the support body.

18. A breaker bar assembly according to claim 16 wherein the axial adjustment device is located at an axial end of the elongate tooth body opposite to said one terminal end.

19. A breaker bar assembly according to claim 17 wherein the axial adjustment device is located at an axial end of the elongate tooth body opposite to said one terminal end.

20. A breaker bar assembly according to claim 19 wherein the body of each tooth is axially slidable through both the upper and lower plates.

21. A breaker bar assembly according to claim 20 wherein each tooth is formed from an elongate bar of constant circular cross-section.

22. A breaker bar assembly according to claim 21 wherein the elongate tooth body of each tooth includes at least one keyway extending longitudinally along its length for co-operation with a projection on the support body to prevent rotation of the elongate bar relative to the support body.
